(19) United States
(12) Patent Application Publication
(10) Pub. No.: US 2012/0232185 A1
(43) Pub. Date: Sep. 13, 2012

(54) BIODEGRADABLE POLYMER AND METHOD FOR MANUFACTURING THE SAME

(75) Inventors: Shinn-Gwo Hong, Chung-Li (TW); Yi-Ming Sun, Chung-Li (TW); Heng-Wei HSU, Taoyuan (TW)

(73) Assignee: YUAN ZE UNIVERSITY, Chung-Li (TW)

(21) Appl. No.: 13/044,803

(22) Filed: Mar. 10, 2011

(51) Int. Cl. C08L 67/07; C08K 5/101

(52) U.S. Cl. 523/124; 525/451; 525/450

(57) ABSTRACT

A biodegradable polymer and its manufacturing method are disclosed. The biodegradable polymer comprises high molecular weight polymer and degradation enhancing polymeric additive. The degradation enhancing polymeric additive is a low molecular weight poly-3-hydroxybutyrate that has a weight-average molecular weight in the range of 50˜2500 g/mole and it can occupies 5%˜30% of the total weight percentage of the biodegradable polymer. The biodegradable polymer and the method for manufacturing the same produce unsaturated compounds of crotonic acid oligomer, which is a low molecular weight poly-3-hydroxybutyrate used as a degradation enhancing polymeric additive, through the degradation process of PHB material and then blend it into high molecular weight polymer. By using its property of easily being degraded by bacteria, the biodegradability and bio-compatibility of the general high molecular weight polymer can be improved. This enables the general plastic material to be degraded by living organism after a period of usage, and thus achieving the benefit of environmental protection.

### BACKGROUND OF THE INVENTION

1. Field of the Invention

The present invention relates to a biodegradable polymer and method for manufacturing the same, and more specifically, which includes a step of blending a low molecular weight poly-3-hydroxybutyrate (LMWPHB), which is used as a degradation enhancing polymeric additive, into a high molecular weight polymer.

2. The Prior Arts

Poly-3-hydroxybutyrate (PHB) is a type of polyhydroxyalkanoate (PHAs) which was discovered as early as 1926. It is an entirely biodegradable polymer which is a thermoplastic material having bio-compatibility, good air tightness, high melting point and high crystallinity. It is a microorganism fermentation type biodegradable polymer and has already been widely applied to various fields of biomedical material and packaging material.

As the awareness of environmental protection rises, environmental sustainability becomes a much more important issue. Although poly-3-hydroxybutyrate (PHB) having larger molecular weight can be degraded by living organism, but the degradation rate is relatively slow. And its property does not meet the requirement for all polymer materials. Other varieties of petrochemical plastics are lack of biodegradable property, some of which cannot be entirely cracked under high temperature combustion with ease and can produce dioxin and other toxins. Therefore, there is a need for a polymer material that has intrinsic properties of plastic; and also has biodegradability as well as biocompatibility.

### SUMMARY OF THE INVENTION

A primary objective of the present invention is to provide a biodegradable polymer. The biodegradable polymer comprises high molecular weight polymer and degradation enhancing polymeric additive. The high molecular weight polymer can be various polyester polymers. The degradation enhancing polymeric additive is a low molecular weight poly-3-hydroxybutyrate (LMWPHB) that has a weight-average molecular weight in the range of 500˜2500 g/mole, more preferably, 1767 g/mole; a number-average molecular weight in the range of 500˜2500 g/mole, more preferably, 1200 g/mole; and it occupies 5%˜30% of the total weight percentage of the biodegradable polymer. The structural formula of the degradation enhancing polymeric additive is shown as follows:

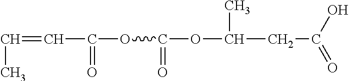

Another objective of the present invention is to provide a manufacturing method for the biodegradable polymer. The method comprises a degradation enhancing polymeric additive preparation step and a blending step. The degradation enhancing polymeric additive preparation step is to separate low molecular weight poly-3-hydroxybutyrate, which is used as a degradation enhancing polymeric additive, from poly-3-hydroxybutyrate (PHB). The blending step is to blend the separated low molecular weight poly-3-hydroxybutyrate into high molecular weight polymer; the blending method can be extrusion, stir mixing and mixing etc. And the degradation enhancing polymeric additive preparation step further comprises a mixing step, an atmosphere introducing step, a heated reaction step, and a rinsing and filtering step. The mixing step is to mix poly-3-hydroxybutyrate (PHB) with polyethylene glycol (PEG) with a specific ratio in a container in a single mixture. The atmosphere introducing step is to introduce nitrogen gas into the container. The heated reaction step is to heat up the container so that the mixture can react under high temperature for a period of time and form a reaction solution. The rinsing and filtering step is to rinse the reaction solution with de-ionized water for several times, separate the product and the un-reacted solution through filtering, and remove water from the product to obtain the low molecular weight poly-3-hydroxybutyrate (LMWPHB) which is used as a degradation enhancing polymeric additive.

The biodegradable polymer and the method for manufacturing the same provided by the present invention produce unsaturated compounds of crotonic acid oligomer, which is a low molecular weight poly-3-hydroxybutyrate used as a degradation enhancing polymeric additive, through the degradation process of PHB material and then blend it into high molecular weight polymer. By using the property (i.e. easily be degraded by bacteria) of the low molecular weight poly-3-hydroxybutyrate (LMWPHB), the biodegradability and bio-compatibility of the general high molecular weight polymer can be improved. This enables the general plastic material to be degraded by living organism after a period of usage, and thus achieving the benefit of environmental protection.

### BRIEF DESCRIPTION OF THE DRAWINGS

FIG. 1 is a flow diagram of the manufacturing method of the biodegradable polymer according to the present invention.

FIG. 2 is a detail flow diagram of the degradation enhancing polymeric additive preparation step.

### DETAILED DESCRIPTION OF THE PREFERRED EMBODIMENT

In the following, the embodiments of the present invention will be further described in accompany with drawings and symbols to enable one skilled in the art to be able to practice it after reading the specification.

A biodegradable polymer mainly comprises high molecular weight polymers and degradation enhancing polymeric additive. The high molecular weight polymers can be at least one of thermoplastic polyvinyl chloride (PVC), acrylate, polyethylene terephthalate (PET), polymethylmethacrylate (PMMA), polyhydroxybutyrate (PHB); thermosetting epoxy resin, unsaturated polyester, and polyurethane (PU). The degradation enhancing polymeric additive is a low molecular weight poly-3-hydroxybutyrate (LMWPHB) that has a weight-average molecular weight in the range of 500˜2500 g/mole, more preferably, 1767 g/mole; a number-average molecular weight in the range of 500˜2500 g/mole, more preferably, 1200 g/mole; and it occupies 5%˜30% of the total weight percentage of the biodegradable polymer. The structural formula of the degradation enhancing polymeric additive is shown as follows:

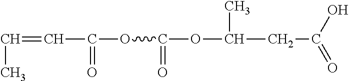

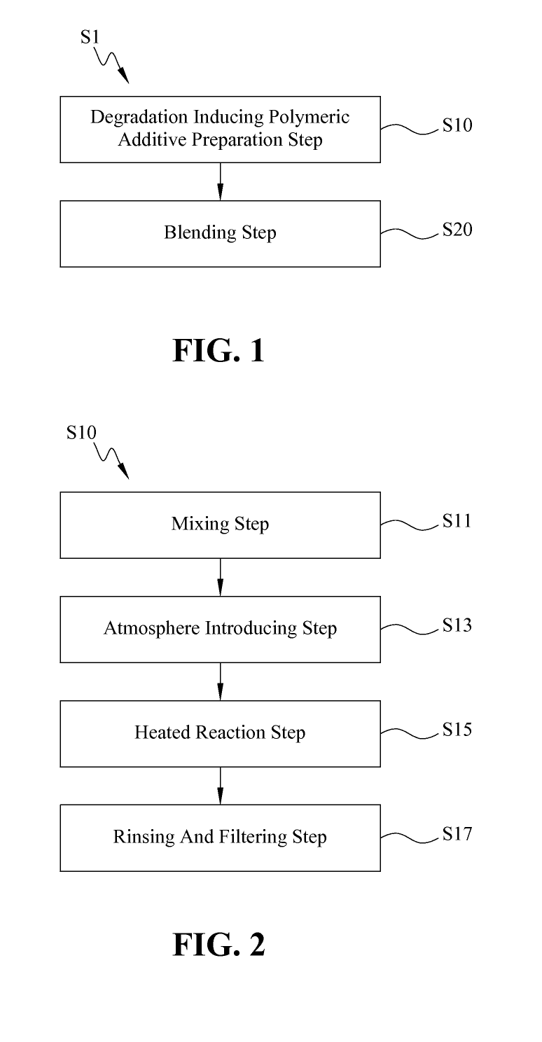

Referring to FIG. 1, which illustrates the flow diagram of the manufacturing method of the biodegradable polymer according to the present invention. As shown in FIG. 1, the biodegradable polymer manufacturing method S1 comprises a degradation enhancing polymeric additive preparation step S10 and a blending step S20. The degradation enhancing polymeric additive preparation step S10 is to separate low molecular weight poly-3-hydroxybutyrate, which is used as a degradation enhancing polymeric additive, from poly-3-hydroxybutyrate (PHB). And the blending step is to blend the separated low molecular weight poly-3-hydroxybutyrate into high molecular weight polymer; the blending method can be extrusion, stir mixing and mixing, etc.

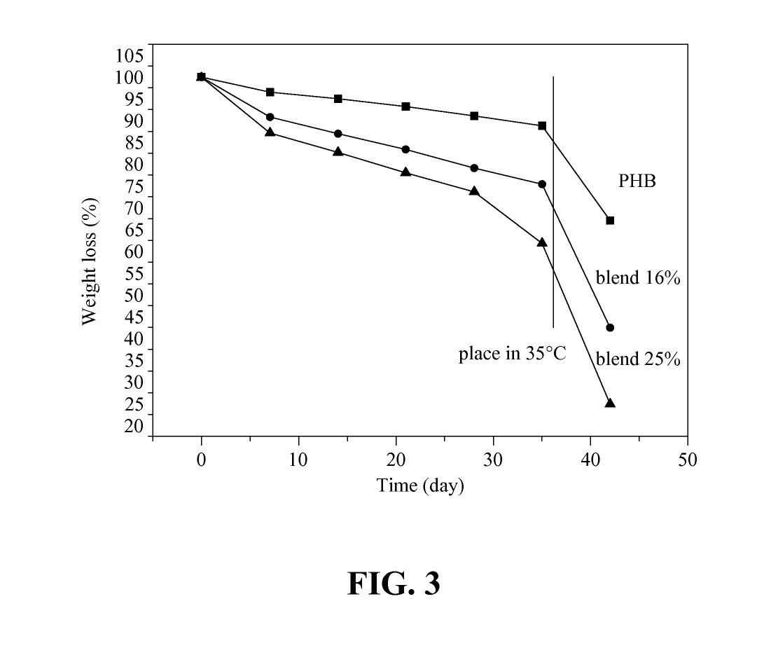

Referring to FIG. 2, which illustrates the detail process flow of the degradation enhancing polymeric additive preparation step. As shown in FIG. 2, the degradation enhancing polymeric additive preparation step S10 comprises a mixing step S11, an atmosphere introducing step S13, a heated reaction step S15, and a rinsing and filtering step S17. The mixing step S11 is to mix poly-3-hydroxybutyrate (PHB) with polyethylene glycol (PEG) with a specific ratio in a container in a single mixture. The specific ration is preferably 1:2 in weight ratio. The atmosphere introducing step S13 is to introduce nitrogen gas into the container. The heated reaction step S15 is to heat up the container so that the mixture can react under high temperature for a specific period of time (e.g. react at 165° C. for 4 hours) and form a reaction solution. The rinsing and filtering step S17 is to rinse the reaction solution with de-ionized water for several times, separate the product and the un-reacted solution through filtering, and remove water from the product to obtain the low molecular weight poly-3-hydroxybutyrate (LMWPHB) which is used as a degradation enhancing polymeric additive.

The feature of the present invention reside in that the biodegradable polymer and the method for manufacturing the same produce unsaturated compounds of crotonic acid oligomer, which is a low molecular weight poly-3-hydroxybutyrate used as a degradation enhancing polymeric additive, through the degradation process of PHB material and then blend it into high molecular weight polymer. By using the property (i.e. easily be degraded by bacteria) of the low molecular weight poly-3-hydroxybutyrate (LMWPHB), the biodegradability and bio-compatibility of the general high molecular weight polymer can be improved. This enables the general plastic material to be degraded by living organism after a period of usage, and thus achieving the benefit of environmental protection.

### Experimental Embodiment

The experimental embodiment provided below compares the poly-3-hydroxybutyrate (PHB) without any low molecular weight poly-3-hydroxybutyrate (LMWPHB) blended therein with PHB having 16% LMWPHB blended therein and PHB having 25% LMWPHB blended therein. The result of the experiment is shown in FIG. 3 and Table 1.

TABLE 1

| | Weight loss (%) | | |
|---|---|---|---|
| | | Blend with | Blend with |
| Time | PHB | 16% LWMPHB | 25% LWMPHB |
| 0~7 days | 3.3 | 9.1 | 12.5 |
| 7~14 days | 1.5 | 3.7 | 4.6 |
| 14~21 days | 1.8 | 1.6 | 4.6 |
| 21~28 days | 2.1 | 4.1 | 4.0 |
| 28~35 days | 2.1 | 3.7 | 11.9 |
| 35~42 days | 21.8 | 32.9 | 36.8 |

As one can see from the experimental embodiment, the degradation of PHB having larger molecular weight can be speeded up by adding LMWPHB.

The above description is intended to explain the prefer embodiment of the invention. It is not intended to limit the present invention in any way. Therefore, any modifications or variations within the spirit of the present invention should be covered by the intended scope of protection.

What is claimed is:

1. A biodegradable polymer comprising:
a high molecular weight polymer; and
a degradation enhancing polymeric additive, being a low molecular weight poly-3-hydroxybutyrate having a weight-average molecular weight in a range of 500˜2500 g/mole, a number-average molecular weight in a range of 500˜2500 g/mole, and occupying 5%˜30% of a total weight percentage of the biodegradable polymer, a structural formula of the low molecular weight poly-3-hydroxybutyrate being shown as follows.

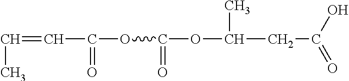

2. The biodegradable polymer according to claim 1, wherein the high molecular weight polymer comprises at least one of polyvinyl chloride (PVC), acrylate, polyethylene terephthalate (PET), polymethylmethacrylate (PMMA), polyhydroxybutyrate (PHB), epoxy resin, unsaturated polyester, and polyurethane (PU).

3. A method for manufacturing biodegradable polymer, comprising:
a degradation enhancing polymeric additive preparation step, to separate a low molecular weight poly-3-hydroxybutyrate which being used as a degradation enhancing polymeric additive, from poly-3-hydroxybutyrate (PHB); and
a blending step, to blend the degradation enhancing polymeric additive into a high molecular weight polymer.

4. The method according to claim 3, wherein said degradation enhancing polymeric additive preparation step comprises:
a mixing step, to mix poly-3-hydroxybutyrate with polyethylene glycol with a specific ratio in a container in a single mixture;
an atmosphere introducing step, to introduce nitrogen gas into the container;
a heated reaction step, to heat up the container so that the mixture can react under a high temperature for a specific period of time and forming a reaction solution; and
a rinsing and filtering step, to rinse the reaction solution with de-ionized water for several times, to separate a product and a un-reacted solution through filtering, and to remove water from the product to obtain the low molecular weight poly-3-hydroxybutyrate (LMWPHB) which being used as the degradation enhancing polymeric additive.

5. The method according to claim 4, wherein the specific ratio is a weight ratio of the poly-3-hydroxybutyrate to the polyethylene glycol of 1:2, the high temperature is 165° C., and the specific time is 4 hours.

6. The method according to claim 3, wherein the high molecular weight polymer comprises at least one of polyvinyl chloride (PVC), acrylate, polyethylene terephthalate (PET), polymethylmethacrylate (PMMA), polyhydroxybutyrate (PHB), epoxy resin, unsaturated polyester, and polyurethane (PU).

7. The method according to claim 3, wherein said blending step is to blend the degradation enhancing polymeric additive into the high molecular weight polymer using at least one of extrusion, stir mixing and mixing.
